(19) United States
(12) Patent Application Publication
(10) Pub. No.: US 2024/0408620 A1
(43) Pub. Date: Dec. 12, 2024

(54) LIQUID-DRIVEN SEPARATION SYSTEM AND METHOD FOR SEPARATING ORGANIC MATERIALS FROM DRENCHED MIXED SOLID WASTE

(71) Applicant: Prototype Garage LLC, Little Canada, MN (US)

(72) Inventors: Haakon Ostenson, Shoreview, MN (US); Greg White, Lino Lakes, MN (US); Olaf Lee, Columbus, MN (US)

(21) Appl. No.: 18/813,609

(22) Filed: Aug. 23, 2024

Related U.S. Application Data
(63) Continuation of application No. PCT/US2023/063552, filed on Mar. 2, 2023.
(60) Provisional application No. 63/316,105, filed on Mar. 3, 2022.

(51) Int. Cl. B04B 5/12; B04B 5/04; B04B 11/02

(52) U.S. Cl. CPC B04B 5/12; B04B 5/0442; B04B 11/02; B04B 2005/0471

(57) ABSTRACT

A liquid-driven separation system for separating hydrated organic materials from drenched mixed solid waste is disclosed. The system includes a funnel-shaped housing defining an upper, open end, a tapering sidewall defining the funnel-shaped housing, and a lower end having a smaller circumference than the upper, open end; vertically offset openings arranged along the tapering sidewall; impellers extend along a vertical axis of the housing; a drive device that rotates the impellers; and an extraction device configured to extract fractions of the mixed solid waste from the housing. A mixture of waste and water is received at the upper end of the housing. The drive device rotates the impellers causing the impellers to generate a centrifugal force such that the mixture spins within the housing and the mixed solid waste separates into fractions at least based on a density of components in the mixed solid waste, for further extraction.

### CROSS-REFERENCE TO RELATED APPLICATIONS

This application is a continuation of International Patent Application No. PCT/US2023/063552, filed on Mar. 2, 2023, which in turn claims priority to U.S. Provisional Application No. 63/316,105 filed on Mar. 3, 2022 entitled “LIQUID-DRIVEN SEPARATION SYSTEM AND METHOD FOR SEPARATING ORGANIC MATERIALS FROM DRENCHED MIXED SOLID WASTE”, which are herein incorporated by reference in its entirety for any useful purpose.

This application relates to commonly owned co-pending U.S. Provisional Patent Application 63/316,092 filed on Mar. 3, 2022 entitled “DRUM FOR PROCESSING MIXED SOLID WASTE”, and U.S. Provisional Patent Application 63/316,112 filed on Mar. 3, 2022 entitled “DRIVE ASSEMBLY”, and U.S. Provisional Patent Application 63/316,120 filed on Mar. 3, 2022 entitled “SELF-ALIGNING TRUNNION”, each of which are herein incorporated by reference in their entireties for any useful purpose.

This application relates to commonly owned, co-pending U.S. patent application having U.S. application Ser. No. 17/401,497, filed on Aug. 13, 2021 and entitled “METHOD AND APPARATUS FOR SEPARATING WASTE MATERIALS”, which claims priority to U.S. Provisional Application Ser. No. 63/071,114, filed on Aug. 27, 2020, each of which are herein incorporated by reference in their entireties for any useful purpose.

### FIELD OF TECHNOLOGY

Provided are waste treatment apparatuses and methods for separating municipal mixed solid waste (MSW) into fractions and extracting the fractions for use in recycling, reclamation, and reduction of landfill waste.

### BACKGROUND

Recycling programs are commonplace for households and businesses, but divert only a portion of recyclable and compostable material away from landfills or incineration. Discarded waste, e.g., municipal mixed solid waste (MSW), collected by waste companies typically contain 40 to 60 wt % recyclable, compostable or biodegradable material. Several approaches have been used to convert MSW into fuel or to reclaim recyclable materials. For instance, U.S. Pat. No. 7,497,392 and U.S. Pat. No. 8,034,132 disclose processes and apparatuses that use a pressure vessel to transform solid waste into fuel by adding steam to the vessel over a period of time. US20160257923 A1 discloses methods and apparatuses that use a vacuum below atmospheric pressure to break cell walls in organic material to increase available free sugars and convertible surface area.

These prior approaches use vessels to treat solid waste using steam, and process the waste at increased temperature and pressure. Moisture, temperature, and pressure varies within the vessel, and rotary agitation can cause the solid waste product to degrade into fuel while separating non-fuel waste components such as metal, glass, and plastic using magnets, density, and particle size-type separating systems such as a trommel or flatbed separator.

While known systems and methods are suited for their intended purposes, the approaches herein provide waste treatment methods and apparatuses for processing waste to prepare the waste for separation into recyclable fractions that does not rely on steam or vacuum, or convert the recyclable material into fuel.

### SUMMARY

A liquid-driven separation system for separating hydrated organic materials from drenched mixed solid waste is disclosed. In one embodiment, the system includes a vertically oriented funnel-shaped housing defining an upper, open end, a tapering sidewall defining the funnel-shaped housing, and a lower end having a smaller circumference relative to the upper, open end; a plurality of vertically offset openings arranged along the tapering sidewall; one or more impellers extending into and along a vertical axis of the housing; a drive device configured to rotate the one or more impellers; and an extraction device configured to extract fractions of the mixed solid waste from the housing. A mixture of the drenched mixed solid waste and water is received at the upper end of the housing, and the drive device rotates the one or more impellers causing the one or more impellers to generate a centrifugal force such that the mixture spins within the housing and the mixed solid waste separates into a plurality of fractions at least based on a density of components in the mixed solid waste. During rotation of the one or more impellers, the extraction device extracts one or more of the fractions of the mixed solid waste from the housing, at least one of the one or more fractions extracted containing the hydrated organic materials.

Optionally in some embodiments, a plurality of openings are configured for ingress of one or more of drenched mixed solid waste or water, or for egress of one or more fractions of the mixed solid waste.

Optionally in some embodiments, one or more of the plurality of openings defined by the housing are configured to receive pumped mixed solid waste and water.

Optionally in some embodiments, the plurality of openings are shaped cylindrically.

Optionally in some embodiments, the one or more impellers comprise a plurality of blades or vanes extending radially perpendicular to the vertical axis of the housing.

Optionally in some embodiments, the upper end of the housing is open.

Optionally in some embodiments, the system includes a conveyor configured to convey the drenched mixed solid waste into the housing at the upper, open end.

Optionally in some embodiments, the plurality of fractions exhibits a first density of 1 g/cm³, and the extraction device extracts the fraction having the first density from the housing.

Optionally in some embodiments, the extraction device is configured as a vacuum water pump. The vacuum water pump is inserted into the spinning mixed solid waste within the housing to collect the fraction having the first density.

Optionally in some embodiments, another of the plurality of fractions exhibits a second density of less than 1 g/cm³. The extraction device or a second extraction device extracts the fraction having the second density from the housing.

Optionally in some embodiments, an extraction device or the second extraction device is configured as a vacuum air pump. The vacuum air pump is inserted into the housing to collect fraction having the second density.

Optionally in some embodiments, another of the plurality of fractions exhibits a third density of greater than 1 g/cm³. The fraction having the third density is collected from a pipe extending from the lower end of the housing.

Optionally in some embodiments, the pipe is coupled to an auger configured to transport the fraction having the third density out of the housing and into a collection receptacle.

Optionally in some embodiments, the pipe and the auger are hydrostatically coupled.

Optionally in some embodiments, the auger is arranged within an elongated tube, the elongated tube comprising one or more ports configured to be coupled to a vacuum.

A method of separating hydrated organic materials from drenched mixed solid waste and water using a liquid-driven separation system is disclosed. In one embodiment the method includes delivering a mixture of drenched mixed solid waste and water to an upper end of a vertically-oriented funnel-shaped housing. The housing includes a tapering sidewall defining a funnel-shaped interior. The method includes rotating one or more impellers extending into the housing along a vertical axis of the housing to cause one or more impellers to generate a centrifugal force such that the mixture spins within the housing and the mixed solid waste separates into a plurality of fractions at least based on a density of components in the mixed solid waste. During rotation of the one or more impellers, an extraction device extracts one or more of the fractions of the mixed solid waste from the housing, at least one of the one or more fractions extracted containing the hydrated organic materials.

Optionally in some embodiments, forming the mixture include providing a particle size of the mixed solid waste at about 0.25 in. to about 3.0 in. The particle size of the mixed solid waste is provided by subjecting the mixed solid waste to a size sorting process. The size sorting process comprises one or more of screening by one or more of a screen, a shaker table or a rotating trommel screen.

A method of reclaiming liquid from a liquid-driven separation system is disclosed. The method includes processing municipal solid waste in system including at least one of a bag splitter, a rotatable drum, conveyor, or a vertically oriented funnel-shaped housing using a liquid; recovering a plurality of portions of the liquid from the system; and returning the plurality of portions of liquid to the system.

Optionally in some embodiments, the method includes sanitizing at least one portion of the plurality of portions of liquid before returning the at least one portion to the system.

Optionally in some embodiments, the method includes the sanitizing includes at least one of subjecting the liquid to an electrical field or filtering the liquid.

### BRIEF DESCRIPTION OF THE DRAWINGS

FIG. 1 illustrates a liquid-driven separation system including a funnel-shaped housing, according to the present disclosure.

FIG. 2 illustrates the funnel-shaped housing of the liquid-driven separation system, according to the present disclosure.

FIG. 3 illustrates a rotor system with impellers in the funnel-shaped housing, according to the present disclosure.

FIG. 4 illustrates lower a portion of the funnel-shaped housing coupled to a conveyor of the liquid-driven separation system, according to the present disclosure.

FIG. 5 illustrates the conveyor of the liquid-driven separation system, according to the present disclosure.

FIG. 6 depicts a flowchart of a method of separating organic materials from drenched mixed solid waste and water using a liquid-driven separation system, according to the present disclosure.

FIG. 7 depicts a simplified process schematic for the system of FIG. 1.

### DETAILED DESCRIPTION

Systems and methods separate municipal mixed solid waste (MSW) into fractions for use in generating one or more recyclable streams for the reduction the overall volume of waste that reaches landfills or incinerators. MSW streams contain a mixture of organic, recyclable and non-recyclable components (e.g., materials that will eventually be sent to a landfill or incinerated). Organics include fruits and vegetables, meat, eggs, eggshells, grains, beans, dairy products, bones (bone meal), paper products (e.g., waxed cardboard, food boxes, napkins, paper towels, paper plates, milk cartons, tea bags, coffee grounds and filters, parchment and waxed papers), hair (pet hair), yard waste, plant and flowers, and so on. Organic materials may also be compostable and biodegradable. Organic materials typically account for 40 to 65 wt % of MSW. Recyclable materials include plastic, glass, metals (e.g., iron and aluminum) and some paper products (e.g., corrugated cardboard). Other materials in the waste stream such as construction materials, concrete, foam, rubber, diapers, and so on, are commonly disposed of in landfills or incinerators, e.g., these materials pass through the waste processing plant without having been separated in the streams of recyclable and organic materials.

According to implementations of the present disclosure, methods and systems provide a liquid-driven separation system for separating fractions of MSW using a funnel-shaped housing configured to receive a mixture of drenched MSW and water, separate the drenched MSW into fractions using centrifugal force generated by a rotor system, resulting in the various MSW fractions separating according to the density of the MSW component, and separately extracting the MSW fractions. The MSW fractions may be individually collected for further downstream processing such as organics reclamation and recycling, to thereby reduce the overall amount of landfill waste.

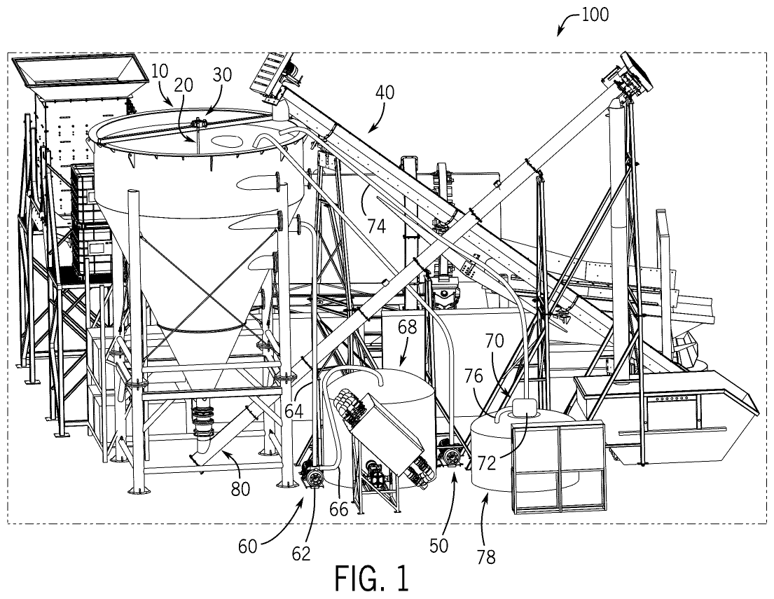

Turning to the Figures, FIG. 1 illustrates a liquid-driven separation system 100 of the present disclosure including a vertically oriented funnel-shaped housing 10 having a vertical axis, a rotor system 20, a drive device 30 for causing the MSW to separate into fractions within the housing 10, a conveyor 40 and a pump system 50 for inputting MSW and water into the housing 10, extraction devices 60, 70 for extracting fractions of the MSW from the housing 10, and a conveyor 80 for conveying fractions of the MSW.

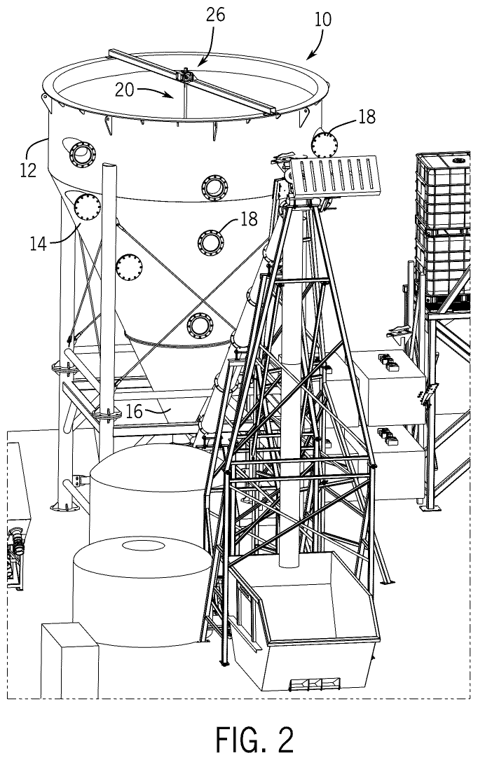

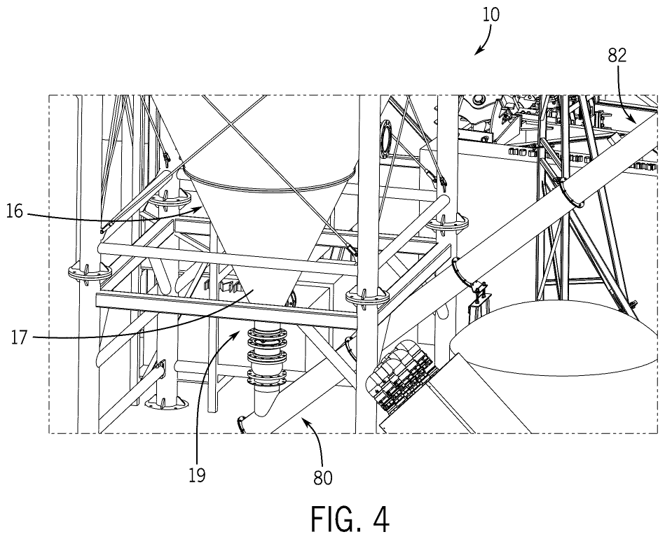

In FIG. 2, the vertically oriented funnel-shaped housing 10 includes an upper end 12, a sidewall 14 with a tapered portion, a lower end 16, and a plurality of vertically offset openings 18 arranged along the sidewall. The funnel-shaped housing 10 may be configured as a tapering cylinder and may have a height of about 10-40 feet. The sidewall 14 may have a height of about 1-10 feet. A bottom end of the housing may extend above the ground by about 3-20 feet. The upper end 12 of the housing 10 may be open and configured to receive MSW and/or water. A diameter of the upper end may be about 10-30 feet. The sidewall 14 of the housing may taper to facilitate defining the funnel shape of the housing 10 and may have an angle of taper of about 5-45 degrees. The lower end 16 of the housing 10 may have a relatively smaller diameter compared to the upper end 12. In some implementations, the lower end 16 of the housing 10 may include a removable portion 17 (FIG. 4). The lower portion 16 and may taper to the terminal end where the housing may define a pipe 19 or tube-shaped opening having a diameter of about 8 to 20 in., about 8-15 in., about 8-12 in., or about 10 in. The lower portion 16 may be replaceable and may have any desired diameter up to about 5 feet. In some implementations, the removable portion 17 may enable this portion to be replaced from the housing 10, for instance to adjust the size of the pipe 19. The interior of the funnel-shaped housing 10 may be substantially smooth and, for instance, may be interrupted primarily by the plurality of openings 18.

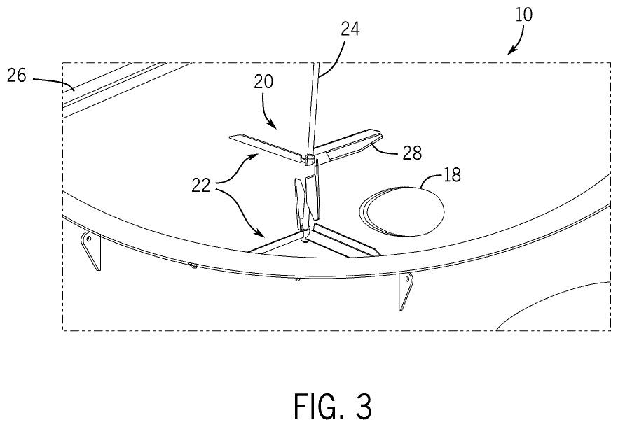

The plurality of openings 18 may be defined by the housing 10 and may be vertically offset and/or horizontally offset from one another. The openings 18 may provide ingress or egress ports for the system 100. For instance, ingress openings may be used for delivering drenched MSW and/or water into the housing 10. Egress openings may be used for removing MSW fractions as provided herein. In some implementations, one or more of the openings 18 may be used for purposes of both ingress and egress, or may be used solely for ingress, or solely for egress. The vertically spaced arrangement of the different openings 18 may facilitate collection of MSW, and for instance, an opening 18 proximate the upper end 12 may be used to collect one type of MSW fraction, an opening 18 proximate the middle of the housing 10 may be used to collect a second, differing type of MSW fraction, and so on. Where openings 18 are positioned on the same horizontal plane, the openings 18 may have the same or a different purpose (e.g., ingress and egress). The openings 18 may have a diameter of about 4-24 inches. At the exterior of the housing 10, the openings 18 may be cylindrically shaped and may include a flange for coupling to conduits such as hoses for ingress and/or egress. At the interior of the housing 10, the openings 18 may be shaped complementary to the interior of the housing 10 as shown in FIG. 3. The number of openings 18 in the housing 10 may vary and may range from 2 to 20, from 2 to 15, from 2 to 10 openings, or 2, 3, 4, 5, 6, 7, 8, 9, 10, 11, 12, 13, 14, 15, 16, 17, 18, 19 or 20 openings arranged along the tapering sidewall. In some implementations, one or more of the openings may be capped by attaching a cap to the flange of the opening 18.

The housing 10 may receive and be coupled to a rotor system 20 configured to be rotated by a drive device 30 of the separation system 100. With reference to FIG. 3, the rotor system 20 may include one or more impellers 22 extending into the housing 10. The impellers 22 may be carried by a drive shaft 24 extending into the housing 10 from the upper end 12 thereof such that the impellers 22 are suspended within the interior of the housing 10. The drive shaft 24 may be held by a crossbar 26 (FIG. 2) coupled to the upper end 12 of the housing 10 and extending across a housing diameter. The crossbar 26 may position the drive shaft 24 such that a vertical axis of the drive shaft 24 extends along a vertical axis of the housing 10 as shown in FIG. 2, but may be positioned at other positions along the housing 10 diameter. The impellers 22 may be provided in one or more sets at varying depths within the interior of the housing 10. For instance a first impeller 22 may extend about 4 to 8 feet into the housing 10 interior from the upper end 12 thereof, and a second impeller 22 may be spaced apart by about 1 foot to 4 feet, such as 2 feet from the first impeller 22. In one example, the drive shaft 24 may have a length of 6 feet, and one of the impellers 22 may be coupled to a terminal end of the drive shaft 24, while the other may be coupled to the drive shaft 24 about 2 feet above the terminal end. The length of the drive 24 shaft may vary and may extend into the housing 10 at varying depths, such as 3 to 15 feet, 3 to 10 feet, 3 to 6 feet, 3 to 4 feet, or may extend into the housing by 10, 20, 30, 40, 50, 60, 70, 80 or 90 percent of the height of the housing 10.

FIG. 3 illustrates the impellers 22 each including three rotors 28, however, more or fewer rotors may be included on the impellers 22 such as one, two, four, five, six, seven, or eight rotors. In addition, the one or more impellers may be configured with vanes in addition to or as an alternative to rotors. The vanes or rotors 28 of the impellers 22 may extend radially from the drive shaft 24, may be arranged perpendicular to the vertical axis of the housing 10, and may have a length of about 12 in. to 72 in.

The rotor system 20 may be configured to cause the drenched MSW and free water to rotate within the housing 10 during operation of the drive device 30 to form a vortex of rotating drenched MSW and free water. For instance, the vanes or rotors 28 of the rotor system 20 may be configured with flanges for urging the materials in the housing 10 in rotation. In some embodiments, the rotor system 20 may be configured to urge drenched MSW down in proximity thereto, such as to urge a downward vertical motion of the MSW in the housing 10 near the rotor system 29 and a counteracting upward vertical motion of the MSW near the walls of the housing 10. In some embodiments, the rotor system 20 may be configured to urge drenched MSW upward in proximity thereto, such as to urge an upward vertical motion of the MSW in the housing 10 near the rotor system 20 and a counteracting downward vertical motion of the MSW near the walls of the housing 10. The drive device 30 may be a motorized device such as an electric motor. In some embodiments, the motor has a power rating of about 2 HP. The motor may be coupled to a transmission that changes a direction, speed, and/or torque of the motor output. For example, the transmission may be a worm-drive gearbox. The rotor system 20 may rotate at a rate of about 20-200 RPM. In a preferred embodiment, the rotor system 20 may rotate at about 80 RPM.

A conveyor 40 and a pump system 50 of the separation system 100 may input MSW and water into the housing 10. The conveyor 40 may be configured as a belt conveyor (FIG. 1) or as an auger for transporting drenched MSW to an ingress of the housing 10 at the upper end 12 thereof, such as at an open end of the housing 10 or at an opening 18 defined in the upper end 12 of the housing 10. As shown in FIG. 1, the conveyor 40 is positioned to deliver drenched MSW to the open end of the housing 10. The drenched MSW transported by the conveyor may have an average particle size ranging from about 1.5 to 3.0 in. The pump system 50 may be configured as a water pump and may transport a mixture of drenched MSW and water to an ingress of the housing 10, such as to the open end of the housing 10 (FIG. 1) or to an opening 18 at the upper end of the housing 10. The particles of MSW in the mixture pumped into the housing 10 by the pump system 50 may have an average particle size ranging from about 0.25 to 1.5 in. Accordingly, in some embodiments, the conveyor 40 and pump system 50 may transport particles of drenched MSW into the housing 10 having an average particle size ranged from about 0.25 to 3.0 in. In further embodiments, the conveyor 40 may transport larger particles of drenched MSW to the housing, such as up to 6.0 in. In yet further embodiments, the pump system may transport particles of drenched MSW into the housing having a particle size as small as 0.01 in.

The extraction devices 60, 70 of the separation system 100 may extract fractions of the MSW from the housing 10 and may be configured as vacuum pumps coupled to conduits such as pipes and/or tubes, as openings 18 in the housing 10, or combinations thereof. In FIG. 1, the extraction device 60 may be configured as a vacuum water pump 62 with conduits 64, 66, where conduit 64 may be inserted into the housing 10 to collect one or more MSW fractions based on the density of the fraction as provided herein, and conduit 66 may deliver the extracted MSW fraction(s) to one or more holding tanks, such as holding tank 68. The extraction device 70 may be configured as a vacuum air pump 72 with conduits 74, 76, where conduit 74 may be inserted into the housing 10 to collect one or more MSW fractions based on the density of the fraction as provided herein, and conduit 76 may deliver the extracted MSW fraction(s) to one or more holding tanks, such as holding tank 78.

In one example, an extraction device with a vacuum water pump may be used to extract MSW particles having a density of about 1 g/cm³, which is the density of water, while an extraction device with a vacuum air pump may be used to extract MSW particles having a density less than 1 g/cm³, e.g., a density less than water. To further this example, the extraction device 60 configured as a vacuum water pump may be inserted below a surface of the mixture of MSW and free water down to a level where the particles having a target density, e.g., approximately equal to 1 g/cm³, and the extraction device 60 may extract the particles having the target density by suctioning. The extraction device 70 configured as a vacuum air pump may be inserted into the housing 10 at a top surface of the mixture such that floating particles of MSW having a target density, e.g., less than approximately 1 g/cm³, may be collected by the extraction device 70 by suctioning. In some embodiments, the extraction device 70 may include a skimmer (e.g., a mesh extending within a frame), a conveyor (e.g., such as a belt such as a porous belt or screw conveyor) that extracts floating particles. In some embodiments, the extraction device 70 includes an apparatus to extract oily or greasy waste that tends to float on or near the top of the floating layer. Although the extraction devices 60, 70 are described as extracting and delivering MSW fractions to holding tanks, it will be understood that the MSW fractions may be delivered to other areas of a waste processing facility such as to sorting systems, collection systems, sterilization systems, or other processing systems (e.g., for the removal of oil or other contaminants).

In some implementations, a portion of the extraction device such as a tube, may be suspended from the crossbar 26 of the housing 10, and may collect the target MSW fraction proximate the vertical axis of the housing 10. This approach may be useful where the target MSW fraction aggregates and concentrates along the central axis of the housing 10, such as when the centrifugal force urges the MSW components towards the center of the housing 10. For instance the tube of the extraction device may extend from the crossbar 26 and be submerged at or proximate the vertical axis into the mass of MSW at a level where the target MSW fraction is aggregated, and vacuum pressure of the pump may be used to suction the target MSW fraction from the mass of MSW in the housing 10. Alternatively, the tube may be suspended from the crossbar 26 and arranged at or just above a floating layer of MSW and vacuum pressure of the pump may be used to suction the components of the floating layer from the mass of MSW.

In additional or alternative implementations, one or more of the extraction devices may extract the target MSW fraction by pulling components of the target MSW fraction tangentially from the sidewalls of the housing interior, and the extraction device may be via a vacuum tube, an opening 18 in the housing 10, or an opening 18 in the housing 10 coupled to a vacuum pump. This approach may be useful where the target MSW fraction aggregates and concentrates along the walls of the housing 10, such as when the centrifugal force urges the MSW components against the internal sidewalls of housing 10. For example, MSW having a density greater than water may be forced to the internal sidewalls of the housing 10, and one or more extraction devices may be used to extract this fraction of MSW from the mass of MSW. In another example, MSW having a density less than water may form a floating layer and portions of the layer forced to the sidewalls of the housing 10 may be collected at the sidewalls.

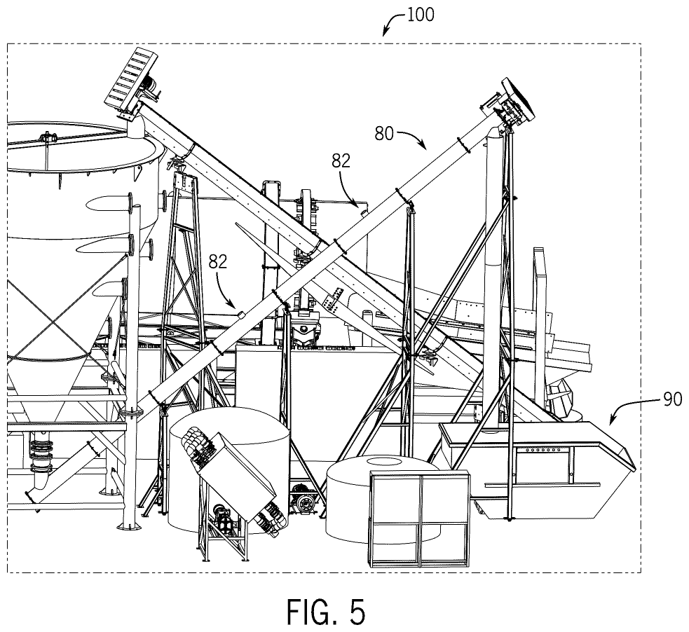

The conveyor 80 of the separation system 100 may convey fractions of the MSW out of the housing 10, such as the fractions of the MSW not collected using the extraction devices 60, 70. The conveyor 80 may be coupled to the lower end 16 of the housing 10, may receive particles of MSW collected at the lower end 16, and may transport the MSW particles out and away from the housing 10. In some implementations, the conveyor 80 may be configured as an auger. The lower end 16 of the housing 10 may be hydrostatically coupled to the conveyor 80, for instance using sealed pipes. For instance, the conveyor 80 may include a transport device such as an auger or belt arranged in an elongated tube, and a proximal end of the elongated tube may be hydrostatically coupled to a distal end of a pipe 19 defining the lower end 16 of the housing 10. The conveyor 80 may be configured to transport MSW particles having a target density, such as a density of greater than 1 g/cm³, e.g., a density greater than water, as well as water. As shown in FIGS. 4 and 5, the conveyor 80 includes an elongated tube and may be hydrostatically coupled to the housing 10. The conveyor 80 may be configured with a height that is taller than a water level in the housing 10. This may enable a water level in the conveyor 80 to correspond to a water level in the housing 10, and further to enable the portion of the conveyor 80 taller than the housing 10 to be devoid of free water. This configuration may facilitate the MSW shedding excess or free water within this portion of the conveyor prior to exiting the conveyor 80 and being provided to a receptacle 90 (FIG. 5). In some embodiments the conveyor 80 may be about 30-40 feet long. The conveyor 80 may be tilted at an angle sufficient to allow for water to drain from the solid material in the conveyor 80 prior to the egress of the solid material from the conveyor 80. In addition, one or more ports 82 may be provided in the tube and may be coupled to a vacuum to facilitate adjusting a water level in the conveyor 80, which may give the MSW particles in the conveyor 80 additional time to shed the excess or free water prior to being collected in the receptacle 90. In addition or alternatively, the conveyor 80 may deliver MSW fractions to other areas of a waste processing facility such as to sorting systems, collection systems, sanitation systems, sterilization systems, or other processing systems (e.g., for the removal of oil or other contaminants).

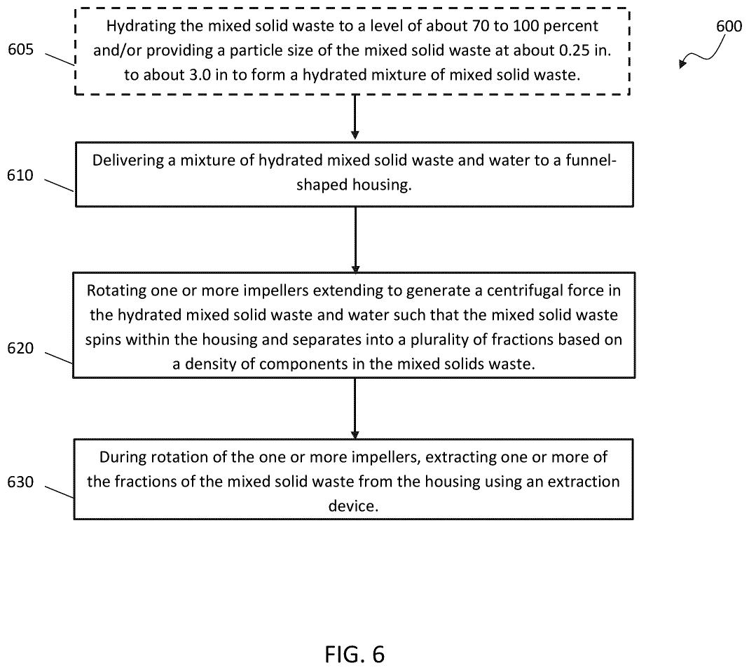

In use, and turning to FIG. 6, depicted is a flowchart of a method 600 of separating hydrated organic materials from a mixture of drenched MSW and water, which may be implemented using the liquid-driven separation system 100. In method 600, the mixture may be delivered to the upper end 12 of the housing 10 in operation 610. The hydrated organic materials in the drenched MSW may have a hydration level of about 70 to 100 percent, while other materials in the MSW such as Styrofoam pieces, plastic, pebbles, glass pieces, may not absorb water but may be wetted in the drenched mixture of MSW. The mixture may be delivered by one or more of the conveyor 40 and pump system 50 and may have an average particle size of about 0.1 in. to about 8.0 in., about 0.25 to about 6.0 in., about 0.25 to about 4.0 in., about 0.25 to about 3.0 in., or up to about 2.0, 2.5 3.0, 3.5, 4.0, 4.5, 5.0, 5.5, 6.5, 7.0, 7.5, 8.0 in. The mixture may be delivered at a rate of about 10-500 lbs. per minute by the conveyor 40, and about 20-400 gallons per minute (GPM) by the pump system 50. In addition, free water may be delivered to the housing at a rate of 20-400 GPM. The housing 10 may be filled with the mixture of MSW and water to a level of about 10-40 feet, or about 0.5-5 feet below a top end of the housing 10. In a preferred embodiment, the conveyor is about 40-50 feet long and has a 12 inch diameter. The conveyor 40 may be a continuous floating screw powered by a 7.5 HP motor and a reduction gearbox rotating at approximately 10-60 RPM. In some embodiments, the pump 50 is a 2 HP centrifugal pump with a solids capacity of ⅜ inch.

In operation 620, the drive device 30 may cause one or more impellers 22 of the rotor device 20 to be rotated within the housing causing the impellers 22 to generate a centrifugal force in the mixture of drenched MSW and free water such that the mixture spins within the housing and the MSW. The centrifugal force generated by the rotation of the rotor device 20 results in the MSW components separating into fractions based on their density relative to water having density of 1 g/cm³. The MSW components having a density less than 1 g/cm³ rise to the surface of the water and may form a floating layer, the MSW components having a density approximately equal to 1 g/cm³ are retained in the water, become hydrated, and may collect and aggregate into a hydrated layer within the housing 10, and the MSW components having a density greater than 1 g/cm³ may fall to the bottom of the housing 10 to form a sunken layer. The floating layer of MSW may generally include components such as plastics, foam, feathers, fabric/textiles, wood, oil, leather, etc. The hydrated layer of MSW may generally include organic components capable of absorbing water such as produce, meat, eggs, eggshells, dairy products, bones, fibrous paper products, hair, yard waste, plant and flowers The sunken layer of MSW may generally include components such as glass, metals, concrete, pebbles, some plastics with a density greater than about 1 g/cm³, and/or combinations of these.

As the mass of MSW rotates within the housing, the rotational speed of the mass of MSW and water may be adjusted by adjusting a rotational speed of the drive device 20. For instance, as the mass of MSW swirls in the housing 10 (e.g., in a clockwise or counter-clockwise direction) and by changing the rotational speed of the impellers 22, the mass of hydrated MSW (e.g., the hydrated layer) having a density of about 1 g/cm³ may be shifted up or down in the housing. In addition, the level of the MSW and water contained in the housing 10 may be adjusted by adjusting a rate of delivery of the MSW and/or water into and out of the housing, e.g., using the conveyor 40, pump system 50, extraction devices 60, 70, conveyor 80, or other means such as water inlet sources and drainage ports. In some embodiments, the MSW may have a residence time in the housing 10 of about 5-60 minutes.

In operation 630, one or more of the extraction devices 60, 70 extracts one or more of the fractions of the MSW from the housing 10. For instance, a MSW fraction having a target density of about, or equal to 1 g/cm³ may be extracted to separate the hydrated layer containing organics from the MSW. For instance, an extraction device 60 configured as a vacuum water pump may be inserted into the housing, and a distal end of a pipe or tube of the extraction device 60 may be used to suction the hydrated layer of MSW from the housing 10. Insertion of the portion of the extraction device 60 into the hydrated layer of MSW may be via the open upper end 12 of the housing, via an opening 18 at or proximate to the upper end 12 or via a middle portion of the housing 10 as provided herein. In some embodiments, the extraction device 60 is a gas-powered pump configured to pump MSW. The extraction device 60 may be in fluid communication with the MSW in the housing 10 via a conduit 64 (e.g., vacuum hose) inserted into the housing at a depth of about 1-15 feet below the surface of the MSW to extract fiber material. In some embodiments the extraction device 60 is an electric pump that extracts fiber material from the housing and feeds the material into a compactor 120 such as a continuous screw press, expeller press, piston, or the like for dewatering the fiber material and recycling a majority of the water back into the system. To further this example, the extraction device 60 may be submerged into the rotating mixture to a level that reaches the hydrated layer of MSW. For instance, where the floating layer of MSW (e.g., having a density less than 1 g/cm³) accounts for the top three feet of the mixture, the extraction device 60 may be submerged at least three feet into the mixture to reach the hydrated layer of MSW having the target density to thereby ensure this MSW fraction is extracted and to avoid extraction of the floating layer (i.e., the non-target layer). In another example, the targeted layers may be extracted by stopping rotation of the MSW (e.g., stopping the rotor system 20) and allowing materials to fall to one or more levels of the housing 10 to be extracted by an auger system.

In addition or alternatively, where a sunken layer of MSW accounts for the bottom three feet of the mixture, the extraction device 60 may be submerged no deeper than three feet from the bottom of the housing to ensure the MSW fraction having the target density is extracted and to avoid extraction of the sunken layer of MSW (i.e., the non-target layer).

Another extraction device 70 may additionally or alternatively be configured as a vacuum air pump and may be used to extract the MSW fraction(s) having a target density of less than about 1 g/cm³, which may be the floating layer of the mixture, and which may be a layer of MSW components that forms above the MSW components having a density equal to or greater than 1 g/cm³ (i.e., the hydrated layer and the sunken layer). As with extraction device 60, the extraction device 70 may be inserted into or proximate the mixture in the housing 10 via the open upper end 12 of the housing, via an opening 18 at or proximate to the upper end 12 or a via middle portion of the housing 10. For instance, the extraction device 70 may be positioned where the floating layer resides and may be used to extract the MSW components from the floating layer by suctioning the components. In some embodiments, the extraction device 70 may be a 3 HP pump configured to create a vacuum pressure at the inlet of the conduit 74 located just above the water/MSW level of the housing 10. A floating arm may locate the conduit 74 a designated distance from surface of the water/MSW and allow the floating assembly (including the inlet of the conduit 74) to raise and lower within the tank to account for water level fluctuations. Exchangeable catch containers may be used to catch and remove solids at ground level.

In some implementations, one or more of the plurality of openings 18 in the housing 10 may serve as an extraction device, or may facilitate the extraction process. For instance, the one or more openings 18 may be coupled to a conduit for collecting the target MSW fraction, and the conduit may optionally be coupled to a vacuum pump, e.g., a vacuum water pump or a vacuum air pump including extraction devices 60, 70.

With respect to the sunken layer of MSW having a density of greater than about 1 g/cm³, the components of this layer may sink to the bottom of the housing 10 by gravity and may exit the pipe 19 at the lower end 16 thereof where the MSW components may be received by the conveyor 80. In some implementations, one or more of the extraction devices may also collect portions of the sunken layer that falls to the bottom of the housing 10, for instance, by inserting the extraction device into the mixture at or below level of the sunken layer. This may be in addition or as an alternative to the use of the pipe 19 and conveyor 80 for removing the dense particles of MSW from the mixture of MSW and water. In some embodiments the density of solids content in the sunken layer is about 5% solids content or 50,000 ppm. The rotational velocity of the water movement due to both the influence of water into and out of the housing 10 as well as the rotor system 20 creates a ‘vortex’ within the housing 10, which may cause relatively less dense material to move toward the central axis of the housing 10 and relatively more dense material toward the outer diameter of the housing 10. This more dense material may sink to the bottom of the housing 10 and to be extracted. The fiber extraction conduit 64 may be located near the central axis of the housing 10. The conduit 64 may include an inlet orifice or other restriction and may include multiple inlets.

Extraction of the various layers or fractions of MSW may be extracted simultaneously or in sequence in any order. In addition, extraction of layers or fractions of MSW may be in a continuous process, a batch process, or combinations thereof. When collected simultaneously, for instance, the extraction device 60 may operate as it is submerged into the mixture of MSW and water to collect the hydrated layer, while the extraction device 70 may collect the floating layer as the extraction device 70 is positioned at or slightly into the floating layer, and while the pipe 19 may collect the sunken layer as the components of this layer sink to the bottom of the housing 10. In another example, the hydrated layer and floating layer may be collected simultaneously using separate extraction devices, while the sunken layer may be collected temporally separately, such as in a batch extraction process (e.g., by draining the sunken layer from the housing 10 via the pipe 19) after collection of the floating and hydrated layers. In another example, the sunken layer may be collected via the pipe 19 and the hydrated layer may be subsequently collected via the pipe 19. In this example, the extraction device 60 may optionally operate to collect the hydrated layer, and the floating layer may be collected by the extraction device 70. When collected in sequence, the sinking, hydrated and floating layers may be collected in any order. In one example, the hydrated layer may be collected prior to the floating layer, or vice versa. In another example, the sunken layer may be collected prior to the hydrated layer, or vice versa. In a further example, the floating layer may be collected prior to the sunken layer, or vice versa.

In some implementations, prior to operation 610, method 600 may further include the optional step of forming the mixture of drenched MSW by drenching components of the MSW with water to cause organics in the MSW to hydrate to a level of about 70 to 100 percent in operation 605. During drenching, organics in the MSW may saturate, hydrate and may form a slurry. Hydration of the MSW components that are capable of absorbing water may facilitate the downstream steps of method 600 because the hydrated MSW may be readily submerged and suspended in the water within the housing 10, while the drenched, non-water absorbing components may readily float or sink to the bottom based on their density. As a result, this may reduce the residence time of the mass of MSW and water in the housing 10 prior to extraction.

The mixture of drenched MSW may additionally or alternatively be formed in operation 605 by ensuring a particle size of the MSW is provided at a range of about 0.25 in. to about 3.0 in, or any range of particle sizes disclosed herein. For instance, the drenched or dry MSW may be subjected to a size sorting process, such as screening, processing on a shaker table 106, and/or passing through openings in a rotating trommel screen, and when sorted in a dry state, the sorted MSW may be drenched. For example, a sprayer 104 may spray water on the MSW before, during or after processing by the shaker table 106. With respect to drenching of the MSW, hydration of organics therein may proceed according to the systems, methods and processes disclosed in the commonly owned, co-pending U.S. Provisional Patent Application filed on the same date herewith entitled “DRUM FOR PROCESSING MIXED SOLID WASTE” and having Attorney Docket No. P294100.US.01, which is incorporated by reference in its entirety for any useful purpose, and further in the commonly owned, co-pending U.S. patent applications having U.S. application Ser. No. 17/401,497, filed on Aug. 13, 2021 and entitled “METHOD AND APPARATUS FOR SEPARATING WASTE MATERIALS”, which claims priority to U.S. Provisional Application Ser. No. 63/071,114, filed on Aug. 27, 2020.

In some implementations, the method 600 may further include an oil removal step, such as skimming oil from a top layer of the rotating MSW prior to the extracting step in operation 630. Other oil removal steps are also contemplated and may include oil extraction from one or more of the fractions recovered from the extraction devices or from the conveyor 80 or oil extraction of the drenched MSW prior to introduction in the housing 10.

In further implementations, the method 600 may additionally or alternatively involve removing water from one or more of the recovered MSW fractions such as through pressing or allowing the recovered MSW fraction to rest separate from free water collected from the extraction devices or from the conveyor 80. For instance, where the conveyor 80 is hydrostatically sealed with the tube 19 of the housing 10, this may result in a water level of the conveyor 80 being substantially the same as the housing 10, and in order to provide the recovered MSW fraction within the conveyor 80 a resting time before depositing in the receptacle 90, a level of water in the conveyor 80 may be reduced by draining water therefrom via one or more ports 82 defined therein. For instance, the ports 82 may be coupled to a vacuum water pump allowing water to be removed from the conveyor 80. This may allow the recovered MSW (e.g., the MSW fraction forming the sunken layer) to travels above the water line in the conveyor 80 for a longer distance such that free water may be drained from the MSW allowing the MSW fines collected to have less saturation.

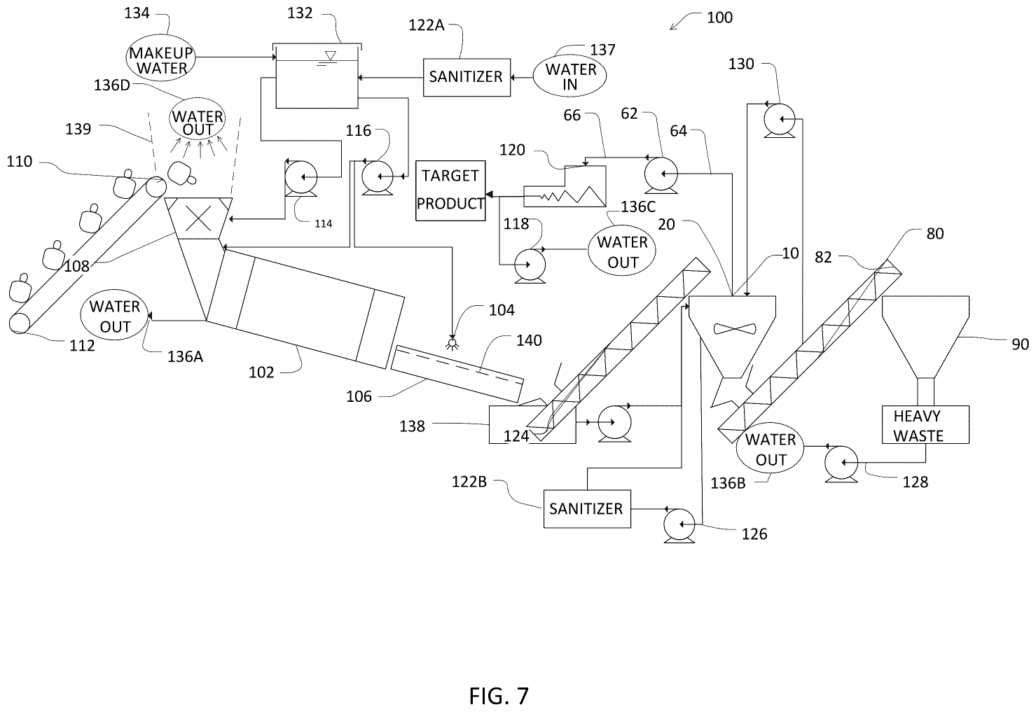

With reference to FIG. 7, a simplified process diagram of a portion of the liquid-driven separation systems described herein is shown. A large portion of the water used in the initial processing and during the MSW saturation process may be delivered to the waste processing system 100, for instance via the conveyor 40 and the pump system 50 (including any of the pumps 62, 114, 116, 118, 124, 128, or 130), or a makeup water inlet 134 while other portions of the water that may escape, e.g., prior to being received by the conveyor 40 or pump system 50, may be collected, then filtered and/or decontaminated, and deposited into one or more holding tanks 132. For instance, locations where the water may escape and be collected include but are not limited to the bag splitter 108 (ingress and egress), the drum 102 (ingress or egress), size sorting apparatuses (e.g., shaker table 106, screens, open/screened trommels), and so on. Sec, e.g., water out location 136A associated with the bag splitter 108, the water out location 136B associated with the heavy waste, the water out location 136 C associated with the compactor 120, mist or spray emitted from the bag splitter at water out location 136D, etc. One or more of the components or portions of the system 100 may include shrouds, curtains, or other barriers suitable to contain and recapture emitted water vapor, aspirations, fumes, sprays, etc.

Other water that proceeds to the downstream processing steps, such as to the system 100 of the present disclosure, may be collected from the funnel-shaped housing 10, from the conveyor 80, the receptacle 90, and so on, and may also be collected, then filtered and/or decontaminated, and deposited into one or more holding tanks 132.

Because water is intermixed and/or absorbed into the MSW it may be contaminated with pathogens and other materials that may be harmful to the environment and people, and it is important to collect and process this water rather than disposing of it. Accordingly, this contaminated water is collected (see., e.g., water in location 137), treated and reused for processing MSW according to the present disclosure. Collection of water may be through processes at any point or location of the MSW waste processing processes described herein, and collection may be via methods such as pressing, draining, vacuuming, pumping, and so on. For instance, entrained water present in the MSW may be pressed from fibers and other water-absorbing materials, e.g., by compactor 120, and/or may be drained, e.g. via gravity, vacuuming, or pumping, from dense, non-water absorbing materials.

Treatment of the contaminated water may include decontamination such as in one or more sanitizers 122A/B. The sanitizers 122A/B may be a single sanitizer, or may be multiple sanitizers. In some embodiments, one or more sanitizers (such as the sanitizer 122A or 122B) are optional. Decontamination facilitates reducing or eliminating pathogens such as harmful bacteria, viruses, and microorganisms. Decontamination processes may include subjecting the MSW and water to decontamination processes, subjecting free water to a decontamination process (e.g., after separation from the MSW), or combinations thereof. For instance, the water and saturated fibrous material having about the same density as water may be extracted from the funnel-shaped housing 10, e.g., as a colloid, and may be treated with an electrical field in a sanitizer 122A, 122B to kill pathogens. Other applicable treatment methods include UV treatment, chemical additives, pH adjustment (e.g., adjustment of pH to 7.5 or above), cleaners, heat processing prior introduction to the funnel-shaped housing 10, heat processing after extraction from the funnel-shaped housing 10, other post-process decontamination steps, and combinations thereof.

Treatment of the contaminated water may also include filtration using one or more filtration stages. Filtration stages may be at any location in the system 100, but particularly may be associated with water out locations 136A, 136B, 136C, and 136D. Water filtration facilitates reducing the amount of particulates in the water, such as particulates at or exceeding 75 microns in size. Providing recycled water with a controlled particulate size facilitates operation of high pressure pumps used in treating the MSW, particularly by ensuring the pump components are not fouled by large particulates. Accordingly, some filtration processes may involve multiple filtration stages, such as a filtration stage that filters out particles 250 microns or larger, and another filtration stage that filters out particles larger than 75 microns.

The treated water may be collected in holding tanks 132, which may be fluidly coupled to pumps (e.g., pumps 114, 116, 118, 126, 128, etc.) that deliver water to the initial MSW processing apparatuses upstream of the waste processing system 100. For instance, holding tanks 132 may be configured as 275 gallon tanks, and multiple tanks 132 may be used to store the treated water for its subsequent use in treating MSW, e.g., raw, unprocessed MSW 110. In some implementations, a portion of the treated water may be fed into the funnel-shaped housing 10. For instance, the water in the funnel-shaped housing 10 may be extracted therefrom, treated, and fed back into the housing 10. When feeding the treated water into the housing 10, the treated water may be delivered tangentially with respect to the sidewall to assist with rotation of the MSW and free water.

A portion of the water used to initially process the raw, bagged MSW may be recycled (see, e.g., water out locations 136A-D), reused water from one or more components of the waste processing system. For instance, about 5 to about 90 percent of the water may be reused, such as about 40, 45, 50, 55, 60, 65, 70, 75, or 80 percent. The reused water may be treated using one or more filtration and decontamination steps, such as in one or more sanitizers 122A-B.

Particularly, water is a key processing component in the waste processing system 100 of the present disclosure and may be introduced in upstream MSW processing steps. Bagged, unprocessed MSW is fed into the system 100 via a conveyor 112 such as a belt conveyor. The conveyor 112 may elevate bags 110 of MSW and deposit them into a bag splitter 108 disclosed in co-pending and co-owned U.S. patent application Ser. No. 17/401,497, filed on Aug. 13, 2021 and entitled “METHOD AND APPARATUS FOR SEPARATING WASTE MATERIALS”. For instance, water may be introduced as the bagged unprocessed MSW 110 (e.g., raw MSW) is initially processed by the force of water weakening or opening bags containing MSW, wetting and drenching MSW and causing the MSW wetted MSW to initially break down using the bag splitter 108. The bag splitter may weaken and/or open bags 110 of unprocessed MSW. For example, water may be supplied to the bag splitter 108 by a pump 114 at sufficiently high pressure to weaken the bags containing the bagged, unprocessed MSW. Additionally, or alternately, a pump 116 may supply water to further wet the MSW at a portion (e.g., the outlet) of the bag splitter 108. This water begins to saturate the water-absorbing components of the MSW and the water and MSW are further processed to facilitate absorption of the water into the MSW, such as by feeding these components to a rotatable drum 102 configured to process the water and MSW. The outlet of the bag splitter 108 may be coupled to an inlet of a rotatable drum 102. One or more portions of the bag splitter 108 may have a water out location 136A to collect excess water from the bag splitter 108. Additionally, or alternately, the bag splitter may include a barrier 139 such as a shroud, curtain, wall, etc. that contains mist, aspirated material, or spray that egresses from the bag splitter. Such a barrier 139 may form a compartment that can be placed under a partial vacuum such that air tends to enter the compartment, preventing or reducing escape of emissions from the bag splitter 108. Such emissions may be collected at a water out location 136D and returned to the system. Other portions of the system 100, such as the drum 102, the shaker table 106, and/or the housing 100 may include similar barriers and/or recovery systems. The drum 102 and drum processing of MSW are described in co-pending and co-owned U.S. Patent Application entitled “DRUM FOR PROCESSING MIXED SOLID WASTE” and having Attorney Docket No. P294100.US.01. For instance, the drum 102 may be configured to retain these components therein over a retention time as the contents are agitated via rotation of the drum 102, which causes the MSW and water to be lifted and dropped into the interior of the drum 102, causing the MSW to be broken down into smaller and smaller pieces. After the MSW is processed in the drum 102, the MSW may be sorted on a shaker table 106. The pump 116 my supply water to the MSW as, and/or after it exits the drum 102, such as while being processed on the shaker table 106 via a sprayer 104.

The shaker table 106 may further sort the MSW exiting the drum 102, such as grading the MSW by size. Some portions of the MSW that do not fall through a screen 140 on the shaker table 106 (i.e., overs) may be discarded to a landfill or incinerator. Portions of the MSW that do fall through the screen 140 (i.e. unders) may be further processed by the system 100. The shaker table 106 may discharge to a catch basin 138 that collects water and unders. A portion of the water may be drawn from the basin 138 such as by a pump 124. The water may be pumped into the housing 10 directly and/or may be sanitized/filtered such as by a sanitizer 122 and then returned to the system 100. The conveyor 40 (e.g., a belt or screw conveyor) may load the unders into the housing 10 as previously described.

In the housing 10, the MSW may be processed as described herein. A portion of the water in the housing 10 may be withdrawn by a pump 126. The pump 126 may feed the water to a sanitizer such as sanitizer 122B before returning the water to the housing 10. An advantage of sanitizing the water in the housing 100 may be to prevent or reduce biofouling of portions of the system 100. As described herein, a portion of the MSW (and water) may be withdrawn from the housing 10 by the conveyor 80. For example MSW with a density greater than 1 g/cm³ (i.e., heavy waste) may be moved from the housing 10 to a receptacle 90 for further processing or disposal. Water may be drawn off the conveyor 80 at one or more ports 82 such as by pump 130. The withdrawn water may be returned directly to the housing 10, and/or may be sanitized/filtered before being returned to the housing or another part of the system 100. Additionally or alternately, the heavy waste may be further separated from water in the receptacle 90. The water mate be returned to the system 100 by the pump 128 via the water out location 136B and may be sanitized/filtered by a sanitizer 122A before being reintroduced to the system 100.

As described herein, the pump 62 may draw a portion of the MSW from the housing via a conduit 64. For example, organic matter and/or fiber materials may be withdrawn from the housing 10. The material may be further processed by a compactor 120 such as a screw pump, expelled pump, piston, or the like. The water liberated from the MSW may be returned to the system 100 via a pump 118 that supplies the water to a sanitizer 122A via the water out location 136C. For instance, the water at water out location 136C may be fed back into the housing 10. In addition or alternatively, the water may be fed tack to the bag splitter 108. The dewatered organic material may form a target product suitable for further use or recycling.

Other examples and implementations are within the scope and spirit of the disclosure and appended claims. For example, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Consequently, variations and modifications commensurate with the teachings, and skill and knowledge of the relevant art, are within the scope of the disclosure.

What is claimed is:

1. A liquid-driven separation system for separating hydrated organic materials from drenched mixed solid waste, comprising:
a vertically oriented funnel-shaped housing defining an upper, open end, a tapering sidewall defining the funnel-shaped housing, and a lower end having a smaller circumference relative to the upper, open end;
a plurality of vertically offset openings arranged along the tapering sidewall;
one or more impellers extending into and along a vertical axis of the housing;
a drive device configured to rotate the one or more impellers; and
an extraction device configured to extract fractions of the mixed solid waste from the housing,
wherein a mixture of the drenched mixed solid waste and water is received at the upper end of the housing, and the drive device rotates the one or more impellers causing the one or more impellers to generate a centrifugal force such that the mixture spins within the housing and the mixed solid waste separates into a plurality of fractions at least based on a density of components in the mixed solid waste, and
wherein, during rotation of the one or more impellers, the extraction device extracts one or more of the fractions of the mixed solid waste from the housing, at least one of the one or more fractions extracted containing the hydrated organic materials.

2. The system of claim 1, wherein the plurality of openings are configured for ingress of one or more of drenched mixed solid waste or water, or for egress of one or more fractions of the mixed solid waste.

3. The system of claim 1, wherein one or more of the plurality of openings defined by the housing are configured to receive pumped mixed solid waste and water.

4. The system of claim 1, wherein the plurality of openings are shaped cylindrically.

5. The system of claim 1, wherein the one or more impellers comprise a plurality of blades or vanes extending radially perpendicular to the vertical axis of the housing.

6. The system of claim 1, wherein the upper end of the housing is open.

7. The system of claim 1, further comprising a conveyor configured to convey the drenched mixed solid waste into the housing at the upper, open end.

8. The system of claim 1, wherein a fraction of the plurality of fractions exhibits a first density of 1 g/cm³, and wherein the extraction device extracts the fraction having the first density from the housing.

9. The system of claim 8, wherein the extraction device is configured as a vacuum water pump, and wherein the vacuum water pump is inserted into the spinning mixture within the housing to collect the fraction having the first density.

10. The system of claim 8, wherein another of the plurality of fractions exhibits a second density of less than 1 g/cm³, and wherein the extraction device or a second extraction device extracts the fraction having the second density from the housing.

11. The system of claim 10, wherein the extraction device or the second extraction device is configured as a vacuum air pump, and wherein the vacuum air pump is inserted into the housing to collect the fraction having the second density.

12. The system of claim 10, wherein another of the plurality of fractions exhibits a third density of greater than 1 g/cm³, and wherein the fraction having the third density is collected from a pipe extending from the lower end of the housing.

13. The system of claim 12, wherein the pipe is coupled to an auger configured to transport the fraction having the third density out of the housing and into a collection receptacle.

14. The system of claim 13, wherein the pipe and the auger are hydrostatically coupled.

15. The system of claim 14, wherein the auger is arranged within an elongated tube, the elongated tube comprising one or more ports configured to be coupled to a vacuum.

16. A method of separating hydrated organic materials from drenched mixed solid waste and water using a liquid-driven separation system, comprising:
delivering a mixture of drenched mixed solid waste and water to an upper end of a vertically-oriented funnel-shaped housing, the housing comprising a tapering sidewall defining a funnel-shaped interior;
rotating one or more impellers extending into the housing along a vertical axis of the housing to cause the one or more impellers to generate a centrifugal force such that the mixture spins within the housing and the mixed solid waste separates into a plurality of fractions at least based on a density of components in the mixed solid waste, and
wherein, during rotation of the one or more impellers, an extraction device extracts one or more of the fractions of the mixed solid waste from the housing, at least one of the one or more fractions extracted containing the hydrated organic materials.

17. The method of claim 16, further comprising a step of forming the mixture of drenched mixed solid waste and water, comprising providing a particle size of the mixed solid waste at about 0.25 in. to about 3.0 in., wherein the particle size of the mixed solid waste is provided by subjecting the mixed solid waste to a size sorting process, and wherein the size sorting process comprises one or more of screening by one or more of a screen, a shaker table or a rotating trommel screen.

18. A method of reclaiming liquid from a liquid-driven separation system comprising:
processing municipal solid waste in system including at least one of a bag splitter, a rotatable drum, conveyor, or a vertically oriented funnel-shaped housing using a liquid;
recovering a plurality of portions of the liquid from the system;
returning the plurality of portions of liquid to the system.

19. The method of claim 18, further comprising sanitizing at least one portion of the plurality of portions of the liquid before returning the at least one portion to the system.

20. The method of claim 19, wherein the sanitizing includes at least one of subjecting the liquid to an electrical field or filtering the liquid.
